(19) United States
(12) Patent Application Publication
(10) Pub. No.: US 2013/0179413 A1
(43) Pub. Date: Jul. 11, 2013

(54) Compressed Distributed Storage Systems And Methods For Providing Same

(71) Applicants: Ahmad Beirami, Atlanta, GA (US); Faramarz Fekri, Atlanta, GA (US); Mohsen Sardari, Atlanta, GA (US)

(72) Inventors: Ahmad Beirami, Atlanta, GA (US); Faramarz Fekri, Atlanta, GA (US); Mohsen Sardari, Atlanta, GA (US)

(73) Assignee: GEORGIA TECH RESEARCH CORPORATION, Atlanta, GA (US)

(21) Appl. No.: 13/825,384

(22) PCT Filed: Sep. 21, 2011
(86) PCT No.: PCT/US11/52652

§ 371 Date: Mar. 21, 2013

Related U.S. Application Data
(60) Provisional application No. 61/384,830, filed on Sep. 21, 2010.

(51) Int. Cl. G06F 17/30

(52) U.S. Cl. CPC G06F 17/30303
USPC 707/693

(57) ABSTRACT

Disclosed are embodiments of a compressed distributed storage system that is designed to satisfy: reliability; minimum storage; efficient update; cost-effective access. An exemplary system can comprise a splitter, an encoder, a parameterizer, and a compressor. In contrast to the prior art, the encoding is performed before the compression. Furthermore, in the exemplary system parameterization, data classification, and memory-assisted compression are key features in efficient compression. The splitter can split an input data file into a plurality of original segments. The encoder can perform fault-tolerant encoding on the plurality of original segments, providing plurality of redundant segments. The parameterizer can classify each redundant segment and form and memorize statistics (context) of each class of the redundant segments. With the class-based context, each redundant segment can be compressed and later decompressed individually. Each compressed redundant segment can be stored at a storage unit of a distributed storage system.

### CROSS-REFERENCE TO RELATED APPLICATIONS

This application claims priority to and the benefit under 35 U.S.C. §119(e) of U.S. Provisional Patent Application No. 61/384,830, filed 21 Sep. 2010, which is incorporated herein by reference in its entirety as if fully set forth below.

### TECHNICAL FIELD

Various embodiments of the present invention relate to distributed storage systems and, particularly, to compression techniques for distributed storage systems.

### BACKGROUND

While the hardware costs of raw disk drive capacity is steadily declining, the overall cost of storage nevertheless continues to rise. The rise of capital expenditures calls for innovations in storage in order to reduce the amount of stored data while maintaining the same level of availability and reliability.

Generally, a storage service is evaluated by a set of criteria that can be divided into two general categories: user experience and provider experience. From the user point of view, the storage provider should provide a highly reliable service with fast access to the data whenever access is needed. From the provider point of view, the provider should be able to guarantee the reliability of the system, provide fast access to the data, and at the same time minimize the cost of storing, updating, and retrieving the data.

### SUMMARY

There is a need for storage systems and methods to compress and store data across distributed storage devices. Preferably, such storage systems and methods are reliable and enable efficient retrieval and data updates. It is to such storage systems and methods that various embodiments of the invention are directed.

An exemplary embodiment of the storage system can comprise a splitter, an encoder, a parameterizer, a compressor, and a plurality of storage units.

The splitter can receive an initial set of data, such as a file, to be compressed and stored by the storage system. The splitter can divide the file into a plurality of original segments, with a total number of K original segments. In an exemplary embodiment, the segments can be of approximately equal size, but this need not be the case. Each segment can comprise a plurality of blocks.

The encoder can perform fault-tolerant encoding on the plurality of original segments, thus resulting in a plurality of encoded segments, with a total number of encoded segments being N encoded segments. Thus, the encoder can increase the total number of segments by N-K. Each of the N segments can then be forwarded to one of the plurality of storage units. In an exemplary embodiment, there can be N storage units, such that one of the encoded segments can be delivered to each storage unit.

The parameterizer can classify each encoded segment into one of P classes, and the parameterizer can update the definition of the applicable class after each segment is classified.

The compressor can memorize statistics about each class, thereby creating a shared context for each class, where a shared context is shared among the various encoded segments belonging to the corresponding class. The compressor can compress each encoded segment individually, using the shared context corresponding to the applicable class of the encoded segment. Thus, during compression of a particular segment, the compressor can leverage redundancies across an entire class of similar segments.

Each storage unit can receive one set of data to store. In some exemplary embodiments, the storage system includes a predetermined number of storage units, and each storage unit can store a fixed maximum size of data. In that case, the compressed segments can be resized by combining or dividing the compressed segments into groups as needed, so as to result in an appropriate number and appropriate sizes of the groups. Each group can be distributed to an assigned storage unit.

These and other objects, features, and advantages of the storage system will become more apparent upon reading the following specification in conjunction with the accompanying drawing figures.

### BRIEF DESCRIPTION OF THE FIGURES

FIG. 1 illustrates a flow diagram of data compression in a storage system, according to an exemplary embodiment of the present invention.

FIG. 2 illustrates a block diagram of a user's view of the storage system, according to an exemplary embodiment of the present invention.

FIG. 3 illustrates a block diagram of a storage control unit of the storage system, according to an exemplary embodiment of the present invention.

FIG. 4 illustrates a block diagram of various internal operations of the parameterization unit and the compression unit, according to an exemplary embodiment of the present invention.

FIG. 5 illustrates a flow diagram of accessing data that is stored in the storage system, according to an exemplary embodiment of the present invention.

FIG. 6 illustrates an architecture of an exemplary computing device used in the storage system, according to an exemplary embodiment of the present invention.

### DETAILED DESCRIPTION

To facilitate an understanding of the principles and features of the invention, various illustrative embodiments are explained below. In particular, the invention is described in the context of being a distributed storage system. Embodiments of the invention, however, need not be limited to this context.

The components described hereinafter as making up various elements of the invention are intended to be illustrative and not restrictive. Many suitable components that can perform the same or similar functions as components described herein are intended to be embraced within the scope of the invention. Such other components not described herein can include, but are not limited to, similar or analogous components developed after development of the invention.

Various embodiments of the present invention are storage systems to compress and store data across distributed storage. Referring now to the figures, in which like reference numerals represent like parts throughout the views, various embodiment of the storage system will be described in detail.

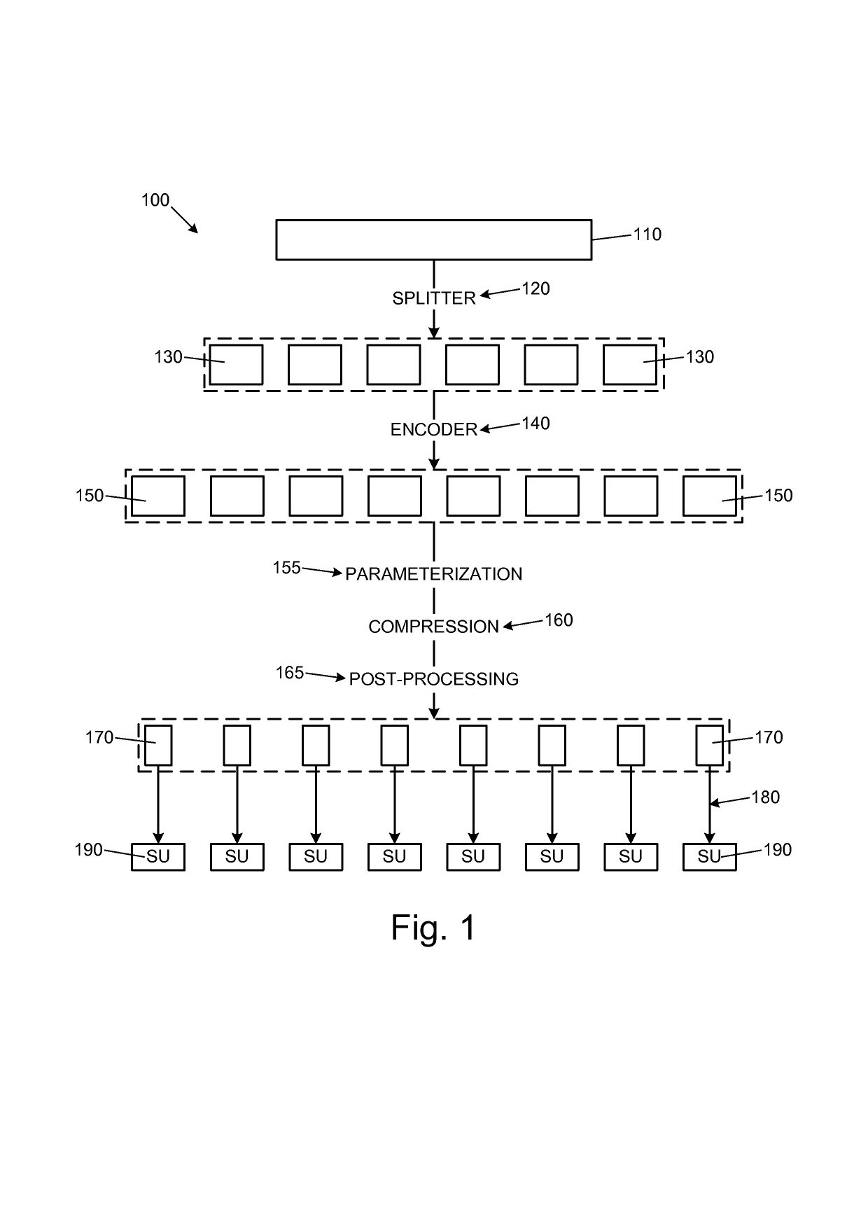

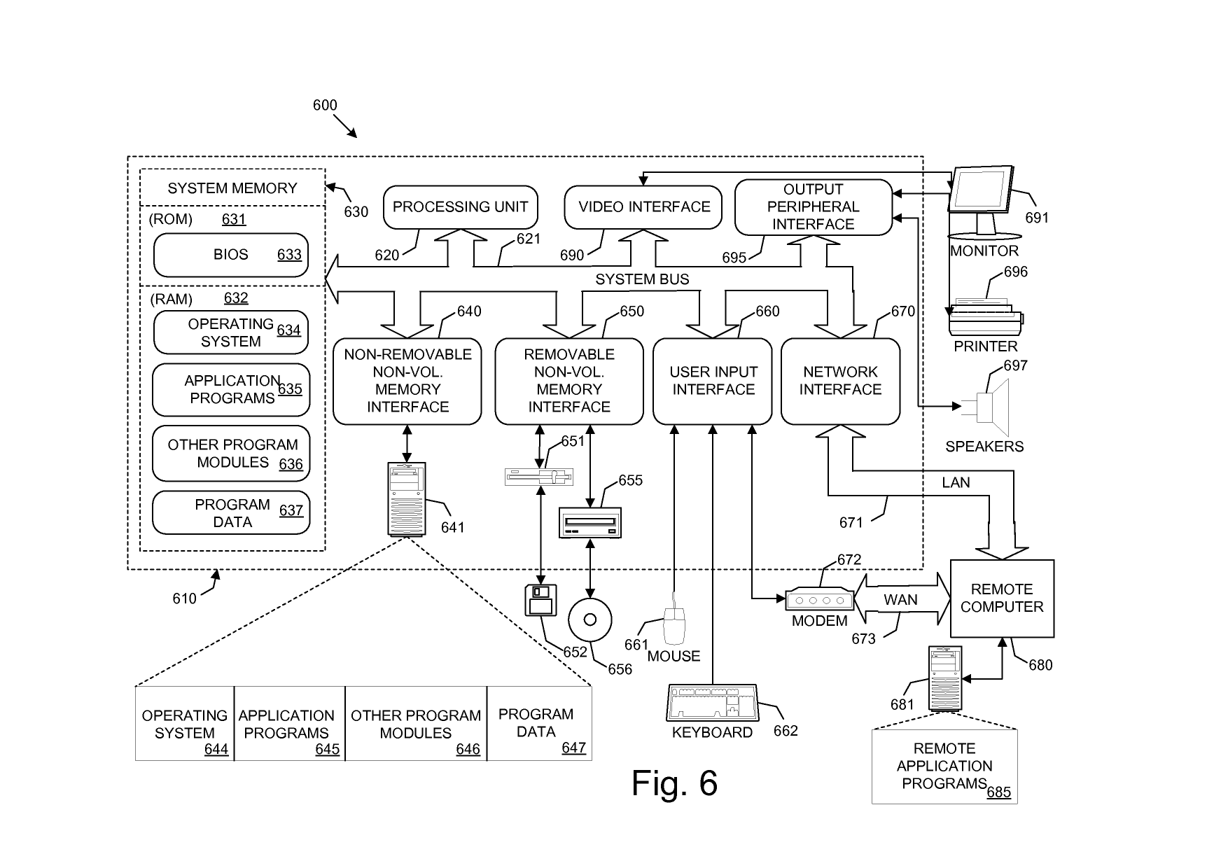

FIG. 1 illustrates a flow diagram of data compression in a storage system, according to an exemplary embodiment of the present invention. As shown in FIG. 1, an exemplary storage system 100 can comprise a splitter 120, an encoder 140, a parameterizer 155, a compressor 160, and a post-processor 165. Each of these components of the storage system 100 can be, in whole or in part, embodied in one or more computing devices 600 (FIG. 6), and the components can be in communication with one another as needed for operation of the storage system 100.

As input, the storage system 100 can receive a data file 110. The splitter 120 can divide the data file 110 into a plurality of original segments 130, comprising K number of segments. In an exemplary embodiment of the storage system 100, the K original segments 130 can retain all of the data from the original data file 110. In some embodiments, the original segments 130 can all be approximately the same size, but this need not be the case.

The encoder 140 can perform fault-tolerant encoding on the plurality of segments 130. The encoding can increase the total size of the data in the segments 130, thus resulting in a plurality of redundant segments 150, number a total of N redundant segments. In some embodiments, N can be greater than K, where the encoder 140 adds N-K segments to add redundancy to the data. In such embodiments, only K redundant segments 150 need be retrieved to recover the entire data file 110, regardless of which K redundant segments 150 are retrieved. Various algorithms are known in the art for adding redundancy to the original segments 130 to meet this criterion.

Each of the redundant segments 150 can be parameterized 155, compressed 160, and post-processed 165, resulting in a corresponding compressed segment 170. Either before or after compression, each redundant segment 150 can be assigned to one of a plurality of storage units 190. While some embodiments of the storage system 100 can perform compression before delivering the redundant segments 150 to their assigned storage units 190, other embodiments may perform compression at the storage units 190 themselves.

For each redundant segment 150, parameterizer 155 can classify the redundant segment into a class and then update the definition of the corresponding class. Thus, after parameterization, each redundant segment 150 can be classified, and each class can be defined. In some embodiments of the storage system 100, the class definitions are retained for use in future compressions, and the class definitions continue to be updated with each new compression.

Based on the class definitions, the compressor 160 can develop a shared context for each class of the redundant segments 150. A shared context can take advantage of the redundancies across an entire class, thus enabling more effective compression than might be achieved if a separate context were created for each redundant segment 150. After the shared context is generated, the compressor 160 can perform compress each redundant segment 150 individually, using the shared context applicable to the class of the redundant segment 150. As a result, while class redundancies are used to achieve effective compression, each compressed segment 170 can be individually decompressed.

The storage system 100 stores each compressed segment 170 at its assigned storage unit 190. In some cases, the storage system 100 comprises N storage units 190, each capable of containing the size of a single compressed segment 170, such that a single compressed segment 170 is stored at each storage unit 190. In other cases however, the post-processor 165 can divide and combine compressed segments 170 into groups before distribution to the storage units 190.

Generally, it is desirable that a storage service provides a highly reliable service with fast access to data, and it is further desirable that the storage service provide fast access to the data while minimizing the cost of storing, updating, and retrieving the data. Various embodiments of the storage system 100 are both reliable and fast. More specifically, an exemplary embodiment of the storage system 100 can meet the following four desirable characteristics of storage systems: (1) reliability, (2) small storage space, (3) small overhead, and (4) efficient access.

Ideal reliability constraints are such that storing the entire data file 110 in a single location is not acceptable, because of the single point of failure. In other words, if the data file 110 were stored on a single storage device, and if that storage device were to fail, the data file would likely be lost. To increase reliability and availability of the data file 110, the storage system 100 can redundantly disperse the data file 110 among N storage locations 190, or nodes. By accessing any subset K of the N nodes 190, one can retrieve the data file 110. This can be achieved by error-control coding that takes the K original segments 130 and input symbols, mapping them to N output symbols.

Often, a data file 110 has a high degree of redundancy, and the removal or reduction of such redundancy can reduce the size of the data file 110. For example, a file comprising text will often frequently repeat the same words, thereby presenting an opportunity to reduce the size of the file by indicating where words repeat instead of actually repeating the words. The storage system 100 can leverage redundancies by identifying redundancies across each class of segments 150.

It is expected that a user will occasionally desire to access stored data, and accordingly, it is desirable that a storage service be efficient in accessing and updating stored data. The naive approach of updating the entire content is inefficient. In exemplary embodiments of the storage system 100, segment-by-segment compression is performed using a context shared among a class. Thus, only segments whose values have been changed need be updated.

Also as a result of the segment-by-segment compression, data can be efficiently accessed in the storage system 100. When a particular portion of data is requested by a user, the storage system 100 need only decompress and provide the data within the segment or segments to which the requested portions belong.

Conventional distributed storage systems compromise on the efficient updating and accessing, in order to reduce storage size. Embodiments of the present invention, however, can provide a small storage size while at the same time not compromising on efficiency of update and access times.

A key distinguishing feature of various embodiments of the present invention, as compared to conventional storage systems, is that the storage system 100 can perform compression on the output of a fault-tolerant encoder 140. This feature of the storage system 100 can drastically improve the storage system's ability to achieve reliability, update efficiency, and access efficiency, and compared to conventional distributed storage systems.

The benefits of an exemplary storage system 100 can be demonstrated by the following example: Consider a database consisting of numerous small-sized (e.g., file) entries. The database is to be stored in a distributed storage system. To achieve access efficiency, the storage system 100 can perform compression on the encoding output. However, none of the prior art work on compression performs well in removing redundancy at encoding output. Therefore, conventional storage systems place the compression module before the error-control coding module, and in these systems, several files must be compressed altogether so as to remove redundancy effectively, given that larger files will generally have greater redundancy. Thus, placing the compressing step before error-control fails to effectively achieve reliability, efficient updating, or efficient accessing.

The following benefits can be present in the storage system 100, as compared to conventional storage systems:
Reduced storage space, by effective compression of small-sized data objects (e.g., files);
Compression occurring after fault-tolerant encoding, which can allow per-file access and cost-effective data updates;
Parameterization of various data sources, which can allow effective compression when the nature of data (e.g., text, html code, images) is unknown in advance; and
Distributed contexts for compression.

These features can provide a dramatic advantage in the storage system 100.

In developing embodiments of the storage system 100, reliability and efficiency were considered at the same time. The reliability is sustained by distributing the data file 110 to be stored among dispersed storage locations 190 and intelligently adding redundancy to the segments 130 of the data file 110 to improve the resilience against storage failures. To achieve efficiency of updating and access, compression can be performed on small portions of data, while simultaneously achieving high compression performance by using shared contexts. The shared contexts can result in a performance analogous to as if a large portion of data were compressed. Shared contexts can exploit the statistical dependencies between various segments.

Conventional systems suggest that redundancy-introduction (e.g., error-control coding) should be performed after compression. The storage system 100 can instead reverse this order, performing redundancy-introduction before compression. This can eliminate the issue of single point of failure while maintaining a high degree of compression performance.

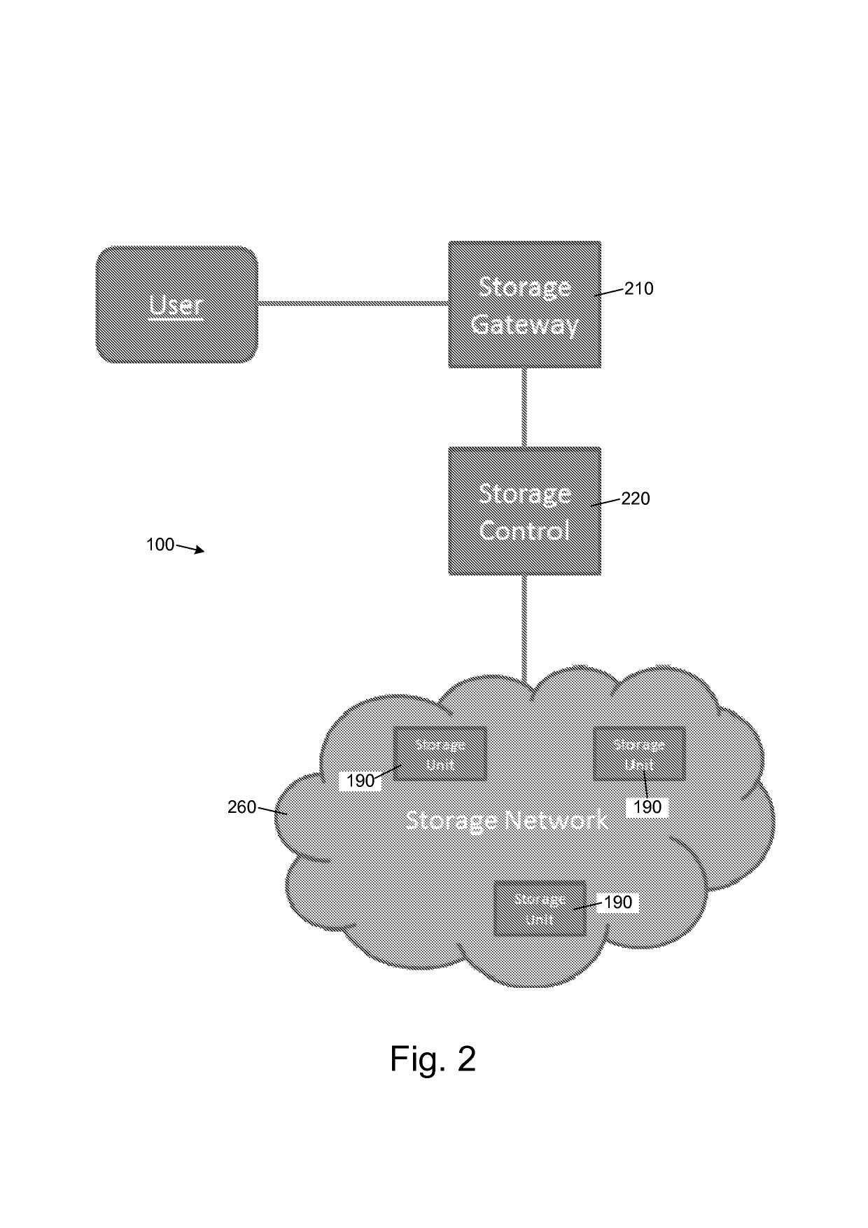

FIG. 2 illustrates a block diagram of a user's view of the storage system, according to an exemplary embodiment of the present invention.

As shown in FIG. 1, the user can perform access and store operations, which can be passed to a storage control 220 through a gateway interface 210. The user may provide unsecured or secured (e.g., encrypted) data to the storage gateway 210. In a store operation, after the gateway 210 receives the data, the gate way 210 can pass the data to the storage control unit 220.

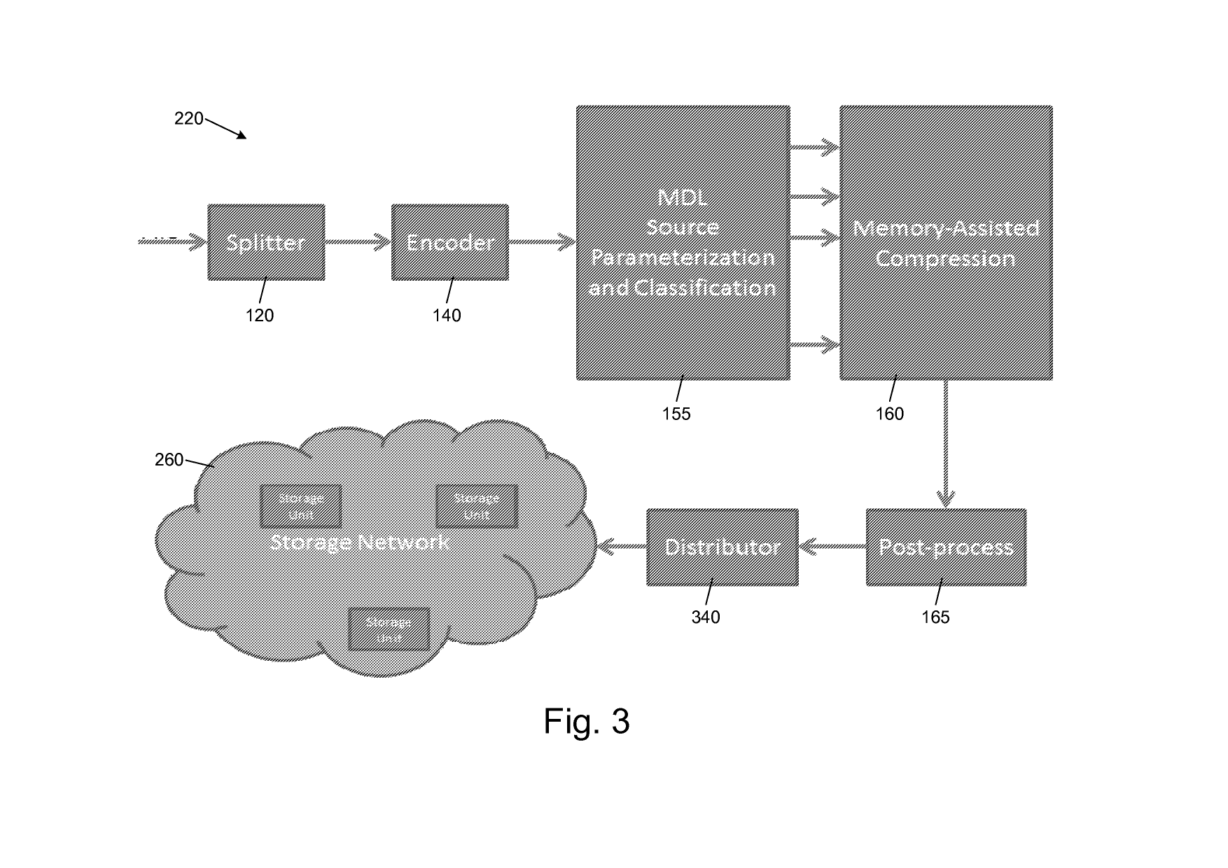

FIG. 3 illustrates a block diagram of a storage control unit of the storage system, according to an exemplary embodiment of the present invention. The storage control 220 can initiate or perform the various operations to store or access the distributed and compressed data file 110. The storage control 220 can comprise, or communicate with, the splitter 120, the encoder 140, a parameterization unit 155, a compression unit 160, a post-processing unit 165, and a distributor 180.

As mentioned above, the splitter 120 can split the data file 110 into a plurality of original segments 130. In some exemplary block-centric embodiments of the invention, the splitter 120 can divide the data file 110 into a plurality of blocks, each of which can act as original segment 130 proceeding into the next step. Each block can be a sequence of bytes or bits, the size of which, in some embodiments, can be defined by a computing device of the storage system 100. In alternative exemplary chunk-centric embodiment of the invention, the splitter 120 can divide the data file 110 into a plurality of chunks, each of which can act as an original segment proceeding into the next step. A chunk size can generally be a manageable size smaller than the original data file 110 and may comprise a plurality of blocks within each chunk.

It will be understood that, although FIG. 1 and this disclosure generally refer to a single data file 110 being divided into segments for compression and distribution, one or more division steps may be provided in advance of dividing the data file 110 into segments 130. For example, in some instances, an input data file 110 can be so large that the splitter 120 can divide the data file 110 into windows, or pieces, each of which can then stand as the data file 110 to be divided into the original segments 130.

The splitter 120 can also play a role in access or updating of data from the data file 110. When the splitter divides the data into original segments 130, the storage control 220 can retain information about where the data file 110 was divided. Thus, when a user later seeks to access or update a portion of the data file 110, information gained by the splitter 120 during original splitting can be used to locate the one or more original segments 130 of the data file 110 that include the desired data.

The encoder 140 can perform fault-tolerant encoding of the original segments 130, so that the entire data file 110 can be retrieved if the user has access to any K of the storage units 190. A prior art error-control coding mechanism, or a modification thereof, can be used by the encoder 140. As input, the encoder 140 can receive the original segments 130 output by the splitter 120. The encoder 140 can output a plurality of redundant segments 150, which can include the original K segments 130 as well as N-K newly added segments. Alternatively, particularly in chunk-centric embodiments, instead of adding new segments to the set of original segments 130, the encoder 140 can increase the size of each original segment 130 by increasing the number of blocks in each chunk, i.e., in each segment 130. In some alternative exemplary embodiments, encoding can be performed at both the block level and the chunk level. For example, the number of blocks can be increased with redundancy; the new total set of blocks (with redundancy) can be combined into chunks; and then the number of chunks can be increased with redundancy. In each of these exemplary embodiments, the encoder 140 can increase the total number of blocks in the original segments 130 with the addition of redundancy, by increasing the number of blocks, the number of chunks, or both.

The parameterization unit 155 can operate on the redundant segments 150, i.e., the total set of original segments 130 and newly added segment. As discussed in greater detail with reference to claim 4 below, the parameterization unit 155 can classify the various redundant segments 150 into a set of P distinct classes. The parameterization unit 155 can examine each redundant segment 150 and place the redundant segment 150 into on the classes. After each redundant segment 150 is classified into a selected class, the corresponding definition of the selected class can be updated to better define the selected class, while including the most recently classified redundant segment 150.

The compression unit 160 can perform compression on each redundant segment 150 of data. The compression unit 160 can comprise a statistics memorizer 410 for each class in which the redundant segments 150 are classified. As an initial step, each statistics memorizer 410 can memorize statistics related to the redundant segments 150 assigned to the corresponding class. Based on these statistics, the compression unit 160 can then generate a context for each class. For each class, the context generated can be shared between the various redundant segments 150 assigned to that class. Redundancy is magnified over larger portions of data, and a shared context can leverage redundancy across an entire class of redundant segments 150. The compression unit 160 can compress each redundant segment 150 individually based on the shared context corresponding to the class of the redundant segment 150, thus achieving better compression than would otherwise be achieved with a unique context.

In some exemplary embodiments, as shown in FIG. 1, compression can occur on each redundant segment 150 before the resulting compressed segments 170 are forwarded to their assigned storage units 190. However, this need not be the case. In some alternative exemplary embodiments, the parameterizer 155 and the compression unit 160 can be distributed across the various storage units 190, and parameterization and compression of each redundant segment 150 can occur at the corresponding assigned storage unit 190.

The post-processing unit 165 can determine how to handle compressed segments 170 and associated metadata (e.g., the context for the compressed segment 170). More specifically, the post-processing unit 165 can decide whether to store the metadata locally or send the metadata extracted by the compression unit 160 to the storage unit 190 to which the associated compressed segment 170 is assigned. The post-processing unit 165 can make this decision based on various criteria, including, for example, the size of compressed segments 170 or the size of metadata.

In a block-centric embodiment of the storage system 100, the post-processing unit 165 can combine the compressed blocks (i.e., compressed segments 170) into groups, each group comprising a plurality compressed blocks.

The distributor 180 can assign and distribute the compressed segments 170 to the various storage units 190. In an exemplary embodiment, the encoder 140 can increase the number of original segments, so as to result in a number N of redundant segments matching the number of storage units 190. Accordingly, there can be a one-to-one correspondence between compressed segments 170 and the storage units 190. The distributor 180 can thus assign each compressed segment 170 to a unique storage unit 190 and can contribute each compressed segment 170 to its assigned storage unit 190. More specifically, in a block-centric embodiment, the distributor 180 can assign each group of compressed blocks to a unique storage unit 190 and can distribute each group to its assigned storage unit 190.

The distributor 180 can retain information about how the compressed segments 170 are distributed. Thus, when data is accessed, the distributor 180 can act as a data collector or retriever, retrieving the compressed segments 170 from the storage units 190 as needed to comply with data access requests.

From a user's point of view, the storage system 100 can appear to comprise a single storage network 260. The distributed aspect of the storage system 100 can be invisible to the user. The storage network 260 can comprise a plurality of storage units 190, each of which can store a compressed segment 170 of the data file 110 and, in some embodiments, the context related to the stored compressed segment 170.

Each storage unit 190 can store a compressed segment 170 received from the distributor 180. As mentioned above, in some embodiments of the storage system 100, the parameterizer 155 and the compression unit 160 can be distributed across the storage units 190, which can perform compressions and decompressions as needed. Thus, in those embodiments, compression can occur at the storage units 190 instead of prior to distribution. In this case, the post-processor 165 can have knowledge of this and can ensure that the distributor 180 distributes the required contexts to the storage units 190 along with the redundant segments 150, which need not already be compressed in that case.

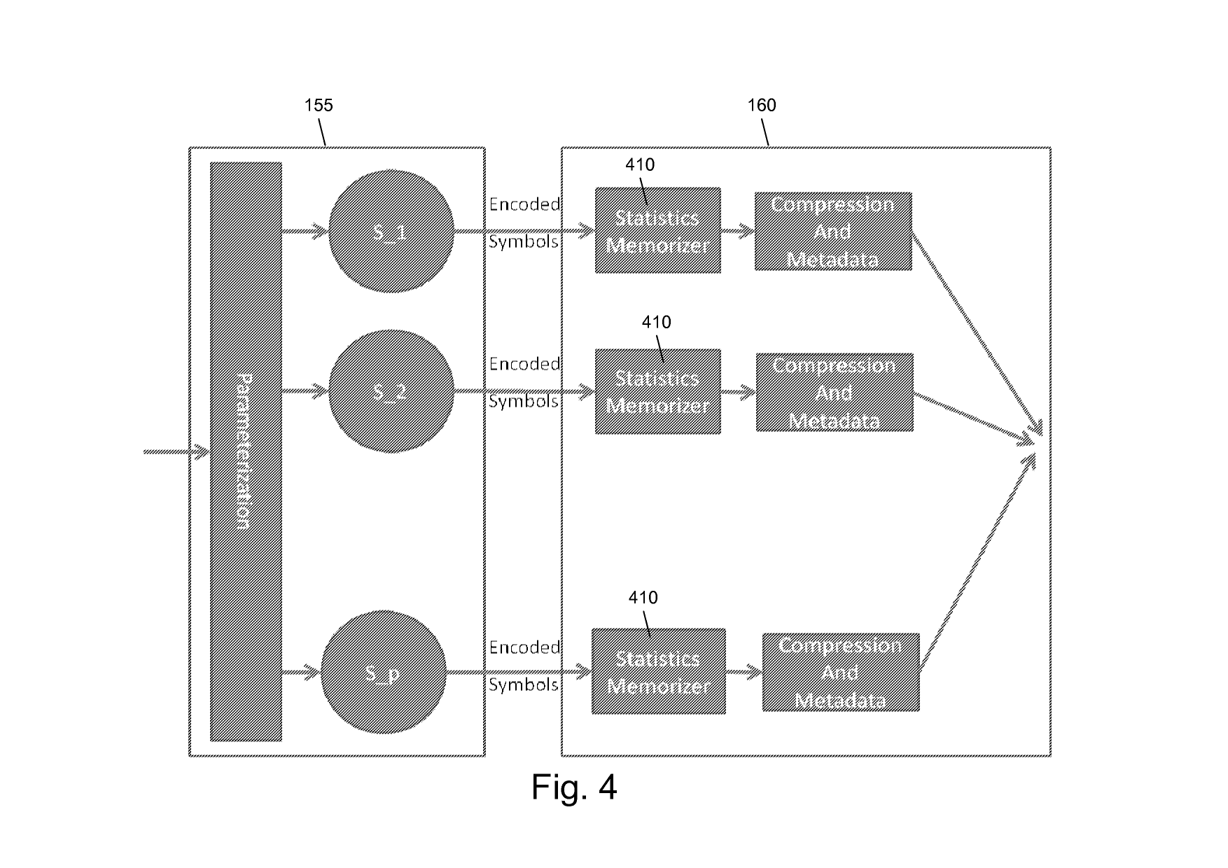

Each redundant segment 150 of the data file 110 can be processed separately by the parameterization unit 155 and the compressor 160. FIG. 4 illustrates a block diagram of various internal operations of the parameterization unit 155 and the compression unit 160, according to an exemplary embodiment of the present invention. As shown, the compressor 160 can comprise one or more statistics memorizers 410, which can be in communication with the parameterization unit 155.

The user data stored in the storage system 100 can comprise various types and classes, such as text, images, or other types of data. Each file or portion of a file can be considered to be from one or more data classes. The parameterization unit 155 can be responsible for extracting a source parameter and classifying the incoming data into different source classes. In other words, the parameterization unit 155 can identify files and sequences that are from similar sources with similar statistics. Similar data can be grouped together, in classes such as the S_1, S_2, and S_p classes illustrated in FIG. 4. Parameterization can be performed such that the compression efficiency is maximized.

Each statistics memorizer 410 of the compressor 160 can be associated with and customized for a particular class of data. A statistics memorizer 410 can have knowledge of various characteristics of its corresponding source class, which characteristics can be identified by the parameterization unit 155 and then forwarded to the applicable statistics memorizer 410. The characteristics for each source class can be updated whenever a new data sequence is observed by the parameterization unit 155. The memorized source characteristics can be stored in a context and used by the compressor 160 for efficient compression.

Compression can occur separately for each redundant segment 150, using the memorized source characteristics related to the class of the redundant segment 150. Although the compression of each redundant segment 150 can depend on the other redundant segments 150 from the same class through memorization, the compression of each redundant segment 150 can be performed separately. Therefore, each compressed segment 170 can be decompressed using the memorized source characteristics, without having to decompress an entire class of compressed segment 170.

Updating of the data file 110 can be performed in much the same way as initial compression and storage. The distributor 180 can retain knowledge about where each compressed segment 170 is stored. Thus, when data is updated by a user, the storage system 100 can compress the updated data and then properly route the data to the appropriate storage unit 190.

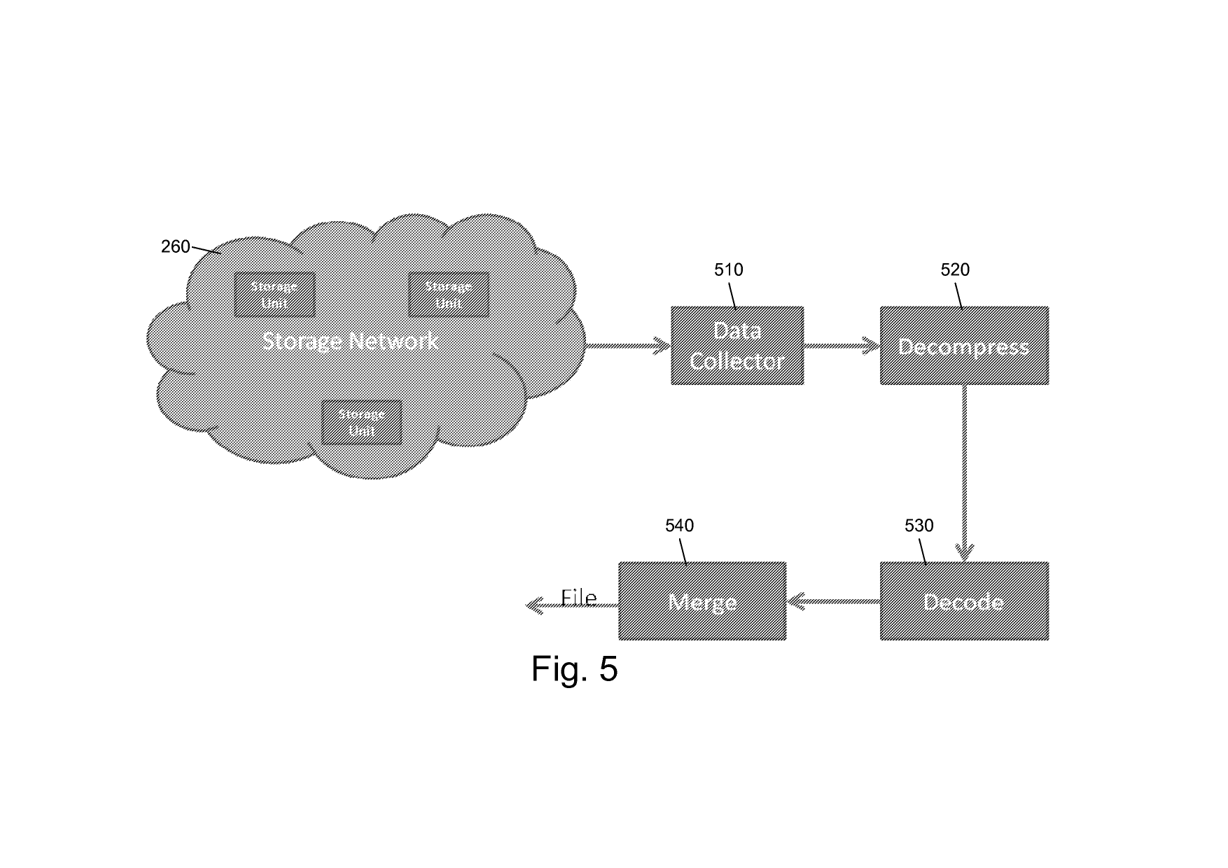

FIG. 5 illustrates a flow diagram of accessing data that is stored in the storage system 100, according to an exemplary embodiment of the present invention.

The access operation can be similar to the store operation but in the reverse order. When an access request is received by the gateway 210, the storage control 220 can collect all the pieces of data required to decode the requested file from the storage units 190. Decompression, decoding, and decryption follow to retrieve each requested segment of the original data file 110. Because the data file 110 is compressed in a segment-by-segment manner, the storage system 100 need not decompress the entire data file 110 to retrieve data.

The data collector 510, which can be analogous to the distributor 180 (and may be the same component or components as the distributor 180) can retrieve compressed segments 170 at the storage units 190 as needed. If applicable, the data collector 510 can communicate with a decompressor at the storage unit 190 to indicate to the central decompressor 520 whether the storage unit 190 already performed the required decompression.

After the data is retrieved from the storage units 190, the decompressor 520 can perform the reverse of compression; the decoder 530 can perform the reverse of the encoder 140, and the merger 540 can perform the reverse of the splitter 120, as needed. The requested data can thus be retrieved and decompressed.

FIG. 6 illustrates an architecture of an exemplary computing device used in the storage system, according to an exemplary embodiment of the present invention. As mentioned above, one or more aspects of the storage system 100 and related methods can be embodied, in whole or in part, in a computing device 600. For example, one or more of the storage devices 190 can be computing devices 600, and the storage control 220 can be a computing device 660 or a portion thereof. FIG. 6 illustrates an example of a suitable computing device 600 that can be used in the storage system 100, according to an exemplary embodiment of the present invention.

Although specific components of a computing device 600 are illustrated in FIG. 6, the depiction of these components in lieu of others does not limit the scope of the invention. Rather, various types of computing devices 600 can be used to implement embodiments of the storage system 100. Exemplary embodiments of the storage system 100 can be operational with numerous other general purpose or special purpose computing system environments or configurations.

Exemplary embodiments of the storage system 100 can be described in a general context of computer-executable instructions, such as one or more applications or program modules, stored on a computer-readable medium and executed by a computer processing unit. Generally, program modules can include routines, programs, objects, components, or data structures that perform particular tasks or implement particular abstract data types.

With reference to FIG. 6, components of the computing device 600 can comprise, without limitation, a processing unit 620 and a system memory 630. A system bus 621 can couple various system components including the system memory 630 to the processing unit 620.

The computing device 600 can include a variety of computer readable media. Computer-readable media can be any available media that can be accessed by the computing device 600, including both volatile and nonvolatile, removable and non-removable media. For example, and not limitation, computer-readable media can comprise computer storage media and communication media. Computer storage media can include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store data accessible by the computing device 600. For example, and not limitation, communication media can include wired media such as a wired network or direct-wired connection, and wireless media such as acoustic, RF, infrared and other wireless media. Combinations of any of the above can also be included within the scope of computer readable media.

The system memory 630 can comprise computer storage media in the form of volatile or nonvolatile memory such as read only memory (ROM) 631 and random access memory (RAM) 632. A basic input/output system 633 (BIOS), containing the basic routines that help to transfer information between elements within the computing device 600, such as during start-up, can typically be stored in the ROM 631. The RAM 632 typically contains data and/or program modules that are immediately accessible to and/or presently in operation by the processing unit 620. For example, and not limitation, FIG. 6 illustrates operating system 634, application programs 635, other program modules 636, and program data 637.

The computing device 600 can also include other removable or non-removable, volatile or nonvolatile computer storage media. By way of example only, FIG. 6 illustrates a hard disk drive 641 that can read from or write to non-removable, nonvolatile magnetic media, a magnetic disk drive 651 for reading or writing to a nonvolatile magnetic disk 652, and an optical disk drive 655 for reading or writing to a nonvolatile optical disk 656, such as a CD ROM or other optical media. Other computer storage media that can be used in the exemplary operating environment can include magnetic tape cassettes, flash memory cards, digital versatile disks, digital video tape, solid state RAM, solid state ROM, and the like. The hard disk drive 641 can be connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6 can provide storage of computer readable instructions, data structures, program modules and other data for the computing device 600. For example, hard disk drive 641 is illustrated as storing an operating system 644, application programs 645, other program modules 646, and program data 647. These components can either be the same as or different from operating system 634, application programs 635, other program modules 636, and program data 637. A web browser application program 635, or web client, can be stored on the hard disk drive 641 or other storage media. The web client 635 can request and render web pages, such as those written in Hypertext Markup Language (“HTML”), in another markup language, or in a scripting language.

A user of the computing device 600 can enter commands and information into the computing device 600 through input devices such as a keyboard 662 and pointing device 661, commonly referred to as a mouse, trackball, or touch pad. Other input devices (not shown) can include a microphone, joystick, game pad, satellite dish, scanner, electronic white board, or the like. These and other input devices are often connected to the processing unit 620 through a user input interface 660 coupled to the system bus 621, but can be connected by other interface and bus structures, such as a parallel port, game port, or a universal serial bus (USB). A monitor 691 or other type of display device can also be connected to the system bus 621 via an interface, such as a video interface 690. In addition to the monitor, the computing device 600 can also include other peripheral output devices such as speakers 697 and a printer 696. These can be connected through an output peripheral interface 695.

The computing device 600 can operate in a networked environment, being in communication with one or more remote computers 680 over a network. For example, and not limitation, each storage unit 190 can be in communication with the storage control 220 over a network. The remote computer 680 can be a personal computer, a server, a router, a network PC, a peer device, or other common network node, and can include many or all of the elements described above relative to the computing device 600, including a memory storage device 681.

When used in a LAN networking environment, the computing device 600 can be connected to the LAN 671 through a network interface or adapter 670. When used in a WAN networking environment, the computing device 600 can include a modem 672 or other means for establishing communications over the WAN 673, such as the internet. The modem 672, which can be internal or external, can be connected to the system bus 621 via the user input interface 660 or other appropriate mechanism. In a networked environment, program modules depicted relative to the computing device 600 can be stored in the remote memory storage device. For example, and not limitation, FIG. 6 illustrates remote application programs 685 as residing on memory storage device 681. It will be appreciated that the network connections shown are exemplary and other means of establishing a communications link between the computers can be used.

As discussed above in detail, various exemplary embodiments of the present invention can provide efficient means to compress and store data. While storage systems and methods have been disclosed in exemplary forms, many modifications, additions, and deletions may be made without departing from the spirit and scope of the system, method, and their equivalents, as set forth in the following claims.

1. A method comprising:
dividing a first data object into a plurality of segments;
encoding the plurality of segments to provide a plurality of redundant segments, the plurality of redundant segments comprising the plurality of segments and one or more additional segments;
parameterizing each of the plurality of redundant segments;
compressing each of the plurality of redundant segments to provide a plurality of compressed segments; and
distributing each of the compressed segments among a plurality of distributed storage locations.

2. The method of claim 1, wherein each of the plurality of segments is compressed according to data extracted during parameterization.

3. The method of claim 1, wherein parameterizing each of the plurality of redundant segments and compressing each of the plurality of redundant segments occurs at the distributed storage locations.

4. The method of claim 1, wherein parameterizing each of the plurality of segments comprises:
extracting a source parameter from a first redundant segment; and
classifying the first redundant segment into a first source class based on the extracted source parameter.

5. The method of claim 4, wherein compressing each of the plurality of redundant segments comprises:
recording the characteristics of the first source class extracted from the first redundant segment;
updating the characteristics of the first source class; and
compressing the first redundant segment using the updated characteristics of the first source class.

6. The method of claim 5, wherein the characteristics of the first source class are updated dynamically after the first redundant segment is classified into the first class, and wherein the characteristics of the first source class are updated dynamically after each classification of a redundant segment into the first source class.

7. The method of claim 5, wherein compression is performed separately on each of the plurality of redundant segments.

8. The method of claim 7, further comprising post-processing the compressed segments after compressing the plurality of redundant segments.

9. The method of claim 8, wherein post-processing the compressed segments comprises deciding whether to retain a corresponding context locally or to send the context to a distributed storage location.

10. The method of claim 8, wherein post-processing further comprises grouping the compressed segments after distributing each of the compressed segments.

11. The method of claim 1, wherein each of the plurality of segments is a chunk comprising a plurality of blocks.

12. The method of claim 1, wherein each of the plurality of segments is a block.

13. The method of claim 12, wherein encoding the plurality of segments to provide the plurality of redundant segments comprises encoding the plurality of blocks, grouping the plurality of blocks into a plurality of chunks, and then encoding the plurality of chunks.

14. (canceled)

15. A method comprising:
dividing a first data object into a plurality of segments;
parameterizing each of the plurality of segments;
compressing each of the plurality of segments to provide a plurality of compressed segments;
encoding the plurality of compressed segments to provide a plurality of redundant segments, the plurality of redundant segments comprising the plurality of segments and one or more additional segments; and
distributing each of the compressed segments among distributed storage locations.

16. (canceled)

17. The method of claim 15, wherein parameterizing each of the plurality of segments comprises:
extracting a source parameter from a first segment; and
classifying the first segment into a source class; and
wherein each of the plurality of segments is compressed according to data extracted during parameterization.

18. The method of claim 17, wherein compressing each of the plurality of segments comprises:
recording the characteristics of any new source class extracted from a segment;
updating the characteristics any previously observed source class; and
compressing each of the segments using the recorded source characteristics of the source class the segment was classified into during parameterizing, wherein metadata is generated for each segment.

19. A system comprising:
a splitter for dividing a data object into smaller segments of data;
an encoder for adding redundancy to the segments of data;
a parameterizer for classifying the segments of data with added redundancy into classes;
a compressor for generating a class context for each class and compressing the classified segments of data based on the corresponding class contexts; and
a plurality of distributed storage locations for storing the compressed data.

20. The method of claim 19, wherein the parameterizer and the compressor are distributed across the plurality of distributed storage locations.

21. The system of claim 20, further comprising a local storage location and a post- processor for determining whether the class context is stored at a local storage location or a distributed storage location.

22. The system of claim 19, further comprising a distributor for distributing the compressed data to the plurality of distributed storage locations.

23. The system of claim 19 further comprising a storage gateway whereby a user can initiate a storage operation.

24. The system of claim 23, further comprising:
a first distributed storage location containing a first segment of the compressed data;
a data collector to fetch the first segment; and
a decompressor to decompress the first segment.

25. The system of claim 24 further comprising a storage gateway whereby a user can initiate an access operation.

26. The system of claim 18, further comprising:
a locator for receiving a new segment of data and for identifying a corresponding first segment of data to be changed at a first distributed storage location;
the compressor being further configured to compress the new segment of data; and
a distributor for distributing the compressed new segment of data to the first distributed storage location for replacing the corresponding first segment of data.

27. The system of claim 26, further comprising a storage gateway whereby a user can initiate an access operation.
